(19) United States
(12) Patent Application Publication
(10) Pub. No.: US 2025/0390179 A1
(43) Pub. Date: Dec. 25, 2025

(54) TOUCH PEN, DISPLAY DEVICE AND ELECTRONIC DEVICE HAVING DISPLAY DEVICE

(71) Applicant: Samsung Display Co., Ltd., Yongin-si (KR)

(72) Inventors: Jae Kyoung KIM, Yongin-si (KR); Seung Hyun MOON, Yongin-si (KR); Hyun Dae LEE, Yongin-si (KR); Kang Bin JO, Yongin-si (KR); Yong Jo KIM, Yongin-si (KR); Chang Hee LEE, Yongin-si (KR)

(21) Appl. No.: 19/237,468

(22) Filed: Jun. 13, 2025

(30) Foreign Application Priority Data
Jun. 19, 2024 (KR) 10-2024-0079318
Sep. 24, 2024 (KR) 10-2024-0129296

(51) Int. Cl. G06F 3/0354; G06F 3/038; G06F 3/041; G06F 3/042

(52) U.S. Cl. CPC G06F 3/03542; G06F 3/038; G06F 3/04166; G06F 3/042

(57) ABSTRACT

A touch pen includes a light emitting unit configured to generate light for touch detection, a pressure sensor configured to generate pressure sensing information by sensing a pen pressure, and a modulation unit configured to determine a characteristic of the light generated by the light emitting unit, based on the pressure sensing information.

### CROSS-REFERENCE TO RELATED APPLICATION

The present application claims priority to and the benefit of Korean Patent Application No. 10-2024-0079318, filed on Jun. 19, 2024, and Korean Patent Application No. 10-2024-0129296, filed on Sep. 24, 2024, in the Korean Intellectual Property Office, the entire disclosures of which are incorporated herein by reference.

### BACKGROUND

### 1. Field

Aspects of embodiments of the present disclosure relate to a touch pen, a display device, and an electronic device.

### 2. Description of the Related Art

As information technology develops, importance of a display device, which is a connection medium between a user and information, is emerging. In response to this, a use of a display device, such as a liquid crystal display device and an organic light emitting display device is increasing. In addition, the display device may perform a user authentication function by sensing a user's fingerprint using a light sensor or may sense an illuminance. In some embodiments, the display device may sense light from a touch pen.

The above information disclosed in this Background section is only for enhancement of understanding of the background of the invention and therefore it may contain information that does not form the prior art.

### SUMMARY

Aspects of some embodiments of the present disclosure are directed to providing a touch pen and a display device capable of improving touch sensing accuracy.

According to some embodiments of the disclosure, there is provided a touch pen including: a light emitting unit configured to generate light for touch detection; a pressure sensor configured to generate pressure sensing information by sensing a pen pressure; and a modulation unit configured to determine a characteristic of the light generated by the light emitting unit, based on the pressure sensing information.

In some embodiments, the modulation unit may be configured to control the light emitting unit to generate light having a first characteristic indicating a touch state in response to a pressure indicated by the pressure sensing information being equal to or greater than a reference value, and may be configured to control the light emitting unit to generate light having a second characteristic indicating a non-touch state in response to the pressure indicated by the pressure sensing information being less than the reference value.

In some embodiments, the modulation unit may be configured to control the light emitting unit to generate light of a first intensity in response to the pressure indicated by the pressure sensing information being equal to or greater than the reference value, and may be configured to control the light emitting unit to generate light of a second intensity lower than the first intensity in response to the pressure indicated by the pressure sensing information being less than the reference value.

In some embodiments, the modulation unit may be configured to control the light emitting unit to generate light that blinks at a first frequency in response to the pressure indicated by the pressure sensing information being equal to or greater than the reference value, and may be configured to control the light emitting unit to generate light that blinks at a second frequency lower than the first frequency in response to the pressure indicated by the pressure sensing information being less than the reference value.

In some embodiments, the modulation unit may be configured to control the light emitting unit to generate light having a first blink pattern corresponding to a first code in response to the pressure indicated by the pressure sensing information being equal to or greater than the reference value, and may be configured to control the light emitting unit to generate light having a second blink pattern corresponding to a second code different from the first code in response to the pressure indicated by the pressure sensing information being less than the reference value.

In some embodiments, in response to a change in the pressure indicated by the pressure sensing information, the modulation unit may be configured to control the light emitting unit to generate light having a characteristic corresponding to the changed pressure.

In some embodiments, the modulation unit may be configured to control the light emitting unit to change an intensity of the generated light when the pressure indicated by the pressure sensing information changes.

In some embodiments, the modulation unit may be configured to control the light emitting unit to change a frequency at which the generated light blinks in response to a change in the pressure indicated by the pressure sensing information.

In some embodiments, the modulation unit may be configured to control the light emitting unit to change a code indicated by a blink pattern of the generated light in response to a change in the pressure indicated by the pressure sensing information.

In some embodiments, the touch pen may further include a communication unit configured to communicate with an external device; and a battery configured to supply a power voltage to at least one of the light emitting unit, the pressure sensor, and the modulation unit, and an intensity of the light generated by the light emitting unit may be configured to change based on communication with the external device.

According to some embodiments of the disclosure, there is provided a display device including: a display panel including a plurality of light sensors that sense light irradiated from a touch pen; a readout circuit configured to receive sensing signals from the plurality of light sensors through readout lines and to generate sensing data based on the sensing signals; and a touch processor configured to generate touch information based on the sensing data, wherein the display panel is configured to determine whether the touch pen touches the display panel based on characteristics of the light.

In some embodiments, the touch processor may include a sensing value storage unit configured to store the sensing data; a light irradiation area determination unit configured to determine a light irradiation area based on the sensing data stored in the sensing value storage unit; a light characteristic detection unit configured to generate a light characteristic signal, based on the light irradiation area and the sensing data; and a touch information generation unit configured to generate the touch information, based on the light irradiation area and the light characteristic signal.

In some embodiments, the light irradiation area determination unit may be configured to receive an intensity of light sensed from a light sensor corresponding to a first position, and may be configured to determine whether the first position is in the light irradiation area, based on whether the intensity of the sensed light is equal to or greater than a first reference value.

In some embodiments, the light characteristic detection unit may be configured to analyze characteristics of light irradiated in the light irradiation area, and the touch information generation unit may be configured to determine whether the touch pen touches the display panel, based on a result of the analysis.

In some embodiments, the light characteristic detection unit may be configured to generate light characteristic information including information relating to the intensity of the light irradiated in the light irradiation area. The touch information generation unit may be configured to determine that the touch pen touches the light irradiation area based on the intensity of the light being equal to or greater than a second reference value, and may be configured to determine that the touch pen does not touch the light irradiation area based on the intensity of the light being less than the second reference value.

In some embodiments, the light characteristic detection unit may be configured to generate light characteristic information including information on a blink frequency of the light irradiated in the light irradiation area. The touch information generation unit may be configured to determine that the touch pen touches the light irradiation area based on the blink frequency of the light being equal to or greater than a third reference value, and may be configured to determine that the touch pen does not touch the light irradiation area based on the blink frequency of the light being less than the third reference value.

In some embodiments, the light characteristic detection unit may be configured to generate light characteristic information including a code corresponding to a pattern of the light irradiated in the light irradiation area. The touch information generation unit may be configured to determine that the touch pen touches the light irradiation area in response to a determination that the code corresponds to a first code, and may be configured to determine that the touch pen does not touch the light irradiation area in response to a determination that the code corresponds to a second code different from the first code.

In some embodiments, the light characteristic detection unit may be configured to generate light characteristic information including information on a position where light of a maximum intensity is irradiated in a light irradiation area, and the touch information generation unit may be configured to generate a touch position based on the light characteristic information.

In some embodiments, the touch information generation unit may be configured to determine a tilt value indicating an angle at which the touch pen is inclined, based on a shape of the light irradiation area and the touch position.

In some embodiments, the touch processor may be configured to count a number of light sensors in the light irradiation area, determine whether the number of light sensors is equal to or greater than a fourth reference value, and reduce sensitivity of the light sensors in response to the number of light sensors being equal to or greater than the fourth reference value.

According to some embodiments of the disclosure, there is provided an electronic device including: a processor configured to provide input image data; and a display device configured to display an image based on the input image data, wherein the display device includes: a display panel including a plurality of light sensors configured to sense light irradiated from a touch pen; a readout circuit configured to receive sensing signals from the plurality of light sensors through readout lines and to generate sensing data based on the sensing signals; and a touch processor configured to generate touch information based on the sensing data, and wherein the display device is configured to determine whether the touch pen touches the display panel based on characteristics of the light

According to the disclosure, a touch pen and a display device capable of improving touch sensing accuracy may be provided.

### BRIEF DESCRIPTION OF THE DRAWINGS

The above and other features of the disclosure will become more apparent by describing in further detail embodiments thereof with reference to the accompanying drawings, in which:

FIG. 1 is a block diagram illustrating a display device according to some embodiments of the present disclosure;

FIG. 2 is a diagram illustrating an example in which a sub-pixel and a light sensor are disposed in a display panel according to some embodiments of the present disclosure;

FIG. 3 is a circuit diagram illustrating the light sensor shown in FIGS. 1 and 2 according to some embodiments of the present disclosure;

FIG. 4 is a timing diagram illustrating a method of driving the light sensor shown in FIG. 3 according to some embodiments of the present disclosure;

FIGS. 5A and 5B are diagrams illustrating a touch pen according to some embodiments of the present disclosure;

FIGS. 6A and 6B are diagrams illustrating an operation of a display device and a touch pen according to some embodiments of the present disclosure;

FIG. 7 is a block diagram illustrating an operation of the touch pen shown in FIGS. 5A and 5B according to some embodiments of the present disclosure;

FIG. 8 is a block diagram illustrating a touch processor of FIG. 1 according to some embodiments of the present disclosure;

FIG. 9 is a diagram illustrating a sensor included in a light irradiation area according to some embodiments of the present disclosure;

FIG. 10 is a flowchart illustrating the operation of a display device that determines whether a light sensed is in a light irradiation area according to some embodiments of the present disclosure;

FIGS. 11A and 11B are diagrams illustrating a pressure change according to touch presence or absence of a touch pen according to some embodiments of the present disclosure;

FIG. 12 is a flowchart illustrating an operation of the touch pen that determines a light characteristic based on touch presence or absence according to some embodiments of the present disclosure;

FIG. 13 is a flowchart illustrating an operation of a display device that determines touch presence or absence of the touch pen based on the light characteristic according to some embodiments of the present disclosure;

FIGS. 14A and 14B are diagrams illustrating a characteristic of a light irradiation area and a touch position when the touch pen is not tilted according to some embodiments of the present disclosure;

FIGS. 15A and 15B are diagrams illustrating the characteristic of the light irradiation area and the touch position when the touch pen is tilted according to some embodiments of the present disclosure;

FIGS. 16A, 16B, and 16C are flowcharts illustrating embodiments in which information indicating a pressure sensed by a pressure sensor is included in emitted light according to some embodiments of the present disclosure;

FIG. 17 is a drawing illustrating a characteristic of the light irradiation area detected when external strong light acts as noise according to some embodiments of the present disclosure;

FIG. 18 is a flowchart illustrating an operation of the display device for reducing noise due to external light according to some embodiments of the present disclosure;

FIG. 19 is a block diagram illustrating an electronic device according to some embodiments of the present disclosure;

FIG. 20 is a diagram illustrating the electronic device of FIG. 19 implemented as a smartphone according to some embodiments of the present disclosure; and

FIG. 21 is a diagram illustrating the electronic device of FIG. 19 implemented as a tablet PC according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or some specification, and should not be interpreted in an idealized or overly formal sense, unless expressly so defined herein.

In the specification, the term “on” used in connection with an element state may refer to an active state of the element, and the term “off” may refer to an inactive state of the element. The term “on” used in connection with a signal received by an element may refer to a signal for activating the element, and the term “off” may refer to a signal for deactivating the element. The element may be activated by a high-level voltage or a low-level voltage. For example, a P-channel transistor (P-type transistor) is activated by a low-level voltage, and an N-channel transistor (N-type transistor) is activated by a high-level voltage. Accordingly, it should be understood that “on” voltages for the P-type transistor and the N-type transistor have opposite (high and low) voltage levels.

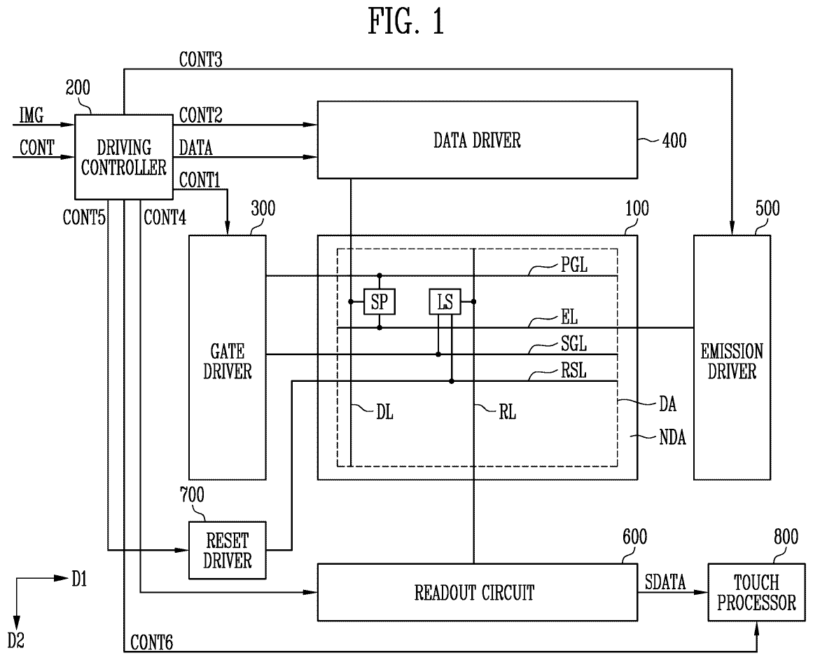

FIG. 1 is a block diagram illustrating a display device according to some embodiments of the present disclosure.

Referring to FIG. 1, the display device may include a display panel 100 and a display panel driver. The display panel driver may include a driving controller 200, a gate driver 300, a data driver 400, an emission driver 500, a readout circuit 600, a reset driver 700, and a touch processor 800. In some embodiments, the driving controller 200 and the data driver 400 may be integrated into one chip.

The display panel 100 may include a display area DA displaying an image and a non-display area NDA disposed adjacent to the display area DA. In some embodiments, the gate driver 300 and the emission driver 500 may be mounted in the non-display area NDA.

The display panel 100 may include a plurality of pixel gate lines PGL, a plurality of data lines DL, a plurality of emission lines EL, and a plurality of sub-pixels SP electrically connected to the pixel gate lines PGL, the data lines DL, and the emission lines EL. The pixel gate lines PGL and the emission lines EL may extend in a first direction D1, and the data lines DL may extend in a second direction D2 crossing the first direction D1.

The display panel 100 may include a plurality of sensing gate lines SGL, a reset line RSL, a plurality of readout lines RL, and a plurality of light sensors LS electrically connected to the plurality of sensing gate lines SGL, the reset line RSL, and the readout lines RL.

In some embodiments, the sensing gate lines SGL may be connected to the gate driver 300, but the disclosure is not limited thereto. For example, the display panel driver may include a separate driver that drives the sensing gate lines SGL.

In some embodiments, the reset lines RSL may be connected to the reset driver 700, but the disclosure is not limited thereto. For example, the reset lines RSL may be driven by a separate driver that drives the gate driver 300, the emission driver 500, or the sensing gate lines SGL rather than the reset driver 700.

The driving controller 200 may receive input image data IMG and an input control signal CONT from a processor (e.g., a graphic processing unit (GPU) or the like). For example, the input image data IMG may include red image data, green image data, and blue image data. In some embodiments, the input image data IMG may further include white image data. As another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, a fifth control signal CONT5, and a data signal DATA based on the input image data IMG and the input control signal CONT.

The driving controller 200 may generate the first control signal CONT1 for controlling an operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling an operation of the data driver 400 based on the input control signal CONT and output the second control signal CONT2 to the data driver 400. The second control signal CONT2 may include a horizontal start signal and a load signal.

The driving controller 200 may generate the data signal DATA by receiving the input image data IMG and the input control signal CONT. The driving controller 200 may output the data signal DATA to the data driver 400.

The driving controller 200 may generate the third control signal CONT3 for controlling an operation of the emission driver 500 based on the input control signal CONT and output the third control signal CONT3 to the emission driver 500. The third control signal CONT3 may include a vertical start signal and an emission clock signal.

The driving controller 200 may generate the fourth control signal CONT4 for controlling an operation of the readout circuit 600 based on the input control signal CONT and output the fourth control signal CONT4 to the readout circuit 600.

The driving controller 200 may generate the fifth control signal CONT5 for controlling an operation of the reset driver 700 based on the input control signal CONT and output the fifth control signal CONT5 to the reset driver 700.

The gate driver 300 may generate gate signals for driving the pixel gate lines PGL and sensing gate lines SGL in response to the first control signal CONT1 received from the driving controller 200. The gate driver 300 may output the gate signals to the pixel gate lines PGL and the sensing gate lines. For example, the gate driver 300 may sequentially output the gate signals to the pixel gate lines PGL and the sensing gate lines SGL.

The data driver 400 may receive the second control signal CONT2 and the data signal DATA from the driving controller 200. The data driver 400 may generate data voltages obtained by converting the data signal DATA into an analog voltage. The data driver 400 may output the data voltages to a data line DL.

The emission driver 500 may generate emission signals for driving the emission lines EL in response to the third control signal CONT3 received from the driving controller 200. The emission driver 500 may output the emission signals to the emission lines EL. For example, the emission driver 500 may sequentially output the emission signals to the emission lines EL.

The readout circuit 600 may generate sensing data SDATA based on sensing signals received from the readout lines RL in response to the fourth control signal CONT4 received from the driving controller 200. In some embodiments, the sensing data SDATA may correspond to a fingerprint image. In this case, the processor or the driving controller 200 may perform a user authentication function using the sensing data SDATA provided from the readout circuit 600. In some other embodiments, the sensing data may include information obtained by sensing light generated by a touch pen. In this case, the sensing data SDATA may be transmitted to the touch processor 800.

The touch processor 800 may generate touch information using the sensing data SDATA provided from the readout circuit 600. The touch information may include information on a position where a touch occurs and a pen pressure by the touch pen. In some embodiments, the touch processor 800 may operate based on a sixth control signal CONT6 received from the driving controller 200. For example, the driving controller 200 may generate the sixth control signal CONT6 to control the touch processor 800 to generate the touch information from the sensing data SDATA when the touch pen is currently in operation. For example, the driving controller 200 may generate the sixth control signal CONT6 to control the touch processor 800 so as not to generate the touch information from the sensing data SDATA when the touch pen is not currently in operation.

Although not shown in FIG. 1, the display panel 100 may include a capacitive touch panel or a pressure-sensitive touch panel. The processor or the driving controller 200 may control the touch processor 800 to generate the touch information from the sensing data SDATA when the touch pen is in operation, and may implement a palm rejection function that controls the touch processor 800 to ignore a sensing signal generated from the touch panel.

Although the touch processor 800 is described as a component included in the display device in FIG. 1, the disclosure is not limited thereto. The touch processor 800 may be included in a processor that communicates with the display device, for example, a microprocessor, a central processing unit, an application processor, or the like.

The reset driver 700 may provide a reset signal to the reset lines RSL in response to the fifth control signal CONT5 received from the driving controller 200. In some embodiments, the reset driver 700 may be commonly connected to all light sensors LS through the reset line RSL. In some other embodiments, the reset driver 700 may be connected to each of the light sensors LS through a plurality of reset lines RSL.

The sub-pixel SP may include a light emitting element. The light emitting element may be a light emitting diode. The light emitting element may be configured of an organic light emitting element (e.g., an organic light emitting diode), an inorganic light emitting element (e.g., an inorganic light emitting diode), a quantum dot/well light emitting element (e.g., a quantum dot/well light emitting diode), or the like. The light emitting element may emit light in one of a first color, a second color, and a third color. A plurality of sub-pixels SP may configure one pixel.

The light sensor LS may include a light receiving element. In some embodiments, the light receiving element may be a photo diode. In some other embodiments, the light receiving element may be configured of a photo transistor.

As an example, light emitted from the light emitting element may be reflected on a user's fingerprint and applied to a light receiving element adjacent to the light emitting element. In addition, the light sensor LS may generate a sensing signal corresponding to a light amount of the light applied to the light receiving element. The touch processor 800 or the driving controller 200 may distinguish a valley and a ridge of the fingerprint according to an intensity of the sensing signal, and obtain a fingerprint image of a user through this.

As another example, light emitted from the touch pen may be applied to a light receiving element positioned near a first end of the touch pen. In addition, the light sensor LS may generate a sensing signal corresponding to a light amount applied to the light receiving element. The readout circuit 600 may generate the sensing data SDATA from the sensing signal, and the touch processor 800 may generate information of whether the touch pen touches or not, a touch position, the pen pressure, and the like based on the sensing data SDATA.

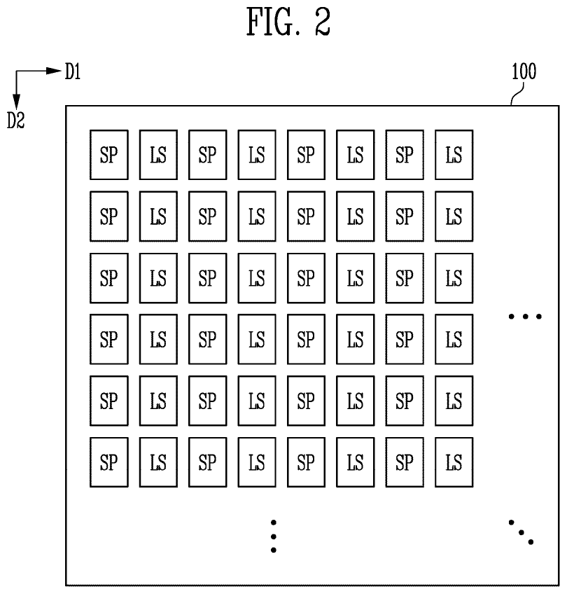

FIG. 2 is a diagram illustrating an example in which the sub-pixel and the light sensor are disposed in the display panel according to some embodiments of the present disclosure.

Referring to FIG. 2, the sub-pixel SP and the light sensor LS may be alternately disposed in the first direction D1 in the display panel 100. For example, based on the first direction D1, the sub-pixel SP may be disposed between two light sensors LS, and the light sensor LS may also be disposed between two sub-pixels SP. For example, the sub-pixels SP and the light sensors LS may be successively disposed in the second direction D2 in the display panel 100. As an example, the sub-pixels SP may be disposed in the second direction D2 in a first column. The light sensors LS may be disposed in the second direction D2 in a second column adjacent to the first column. As a result, in some embodiments shown in FIG. 2, a ratio of the number of sub-pixels SP and the number of light sensors LS may be 1:1.

However, this is merely an example, and the disclosure is not limited thereto. For example, when each of the pixels of the display panel includes three sub-pixels, one light sensor may be disposed for each of the three sub-pixels. In this case, the ratio of the number of sub-pixels SP and the number of light sensors LS may be 3:1. As another example, when each of the pixels of the display panel includes four sub-pixels, one light sensor may be disposed for each of the four sub-pixels. In this case, the ratio of the number of sub-pixels SP and the number of light sensors LS may be 4:1. In addition to this, the ratio of the number of sub-pixels SP and the number of light sensors LS may be determined in various other suitable methods, and a disposition method of the sub-pixels SP and the light sensors LS may also be determined in various suitable methods. As the number of light sensors LS disposed on the display panel 100 increases, resolution for sensing light may increase.

FIG. 3 is a circuit diagram illustrating the light sensor shown in FIGS. 1 and 2 according to some embodiments of the present disclosure.

Referring to FIG. 3, the light sensor LS may include a first sensing transistor TS1, a second sensing transistor TS2, a third sensing transistor TS3, and a light receiving element OPD. The first sensing transistor TS1 may generate a sensing signal. The second sensing transistor TS2 may transmit the sensing signal to the readout line RL in response to the sensing gate signal GS. The third sensing transistor TS3 may initialize a control node of the first sensing transistor TS1 in response to a reset signal RS provided through a reset line RSL. The light receiving element OPD may be connected to the control node of the first sensing transistor TS1. For example, the sensing signal may be a current generated by the first sensing transistor TS1.

For example, the first sensing transistor TS1 may include a control electrode connected to a first sensing node SN1, a first electrode receiving a common voltage VCOM, and a second electrode connected to a first electrode of the second sensing transistor TS2. The second sensing transistor TS2 may include a control electrode for receiving the sensing gate signal GS, the first electrode connected to the second electrode of the first sensing transistor TS1, and a second electrode connected to the readout line RL. The light receiving element OPD may include a first electrode connected to the first sensing node SN1 and a second electrode receiving the second power voltage ELVSS (e.g., the low power voltage). The third sensing transistor TS3 may include a control electrode receiving the reset signal RSL, a first electrode receiving a reset voltage VRST, and a second electrode connected to the first sensing node SN1.

For example, in some embodiments, the first and second sensing transistors TS1 and TS2 may be implemented as PMOS transistors, and the third sensing transistor TS3 may be implemented as an NMOS transistor. However, the disclosure is not limited thereto. The light sensor may be implemented in various methods different from that of the circuit diagram shown in FIG. 3.

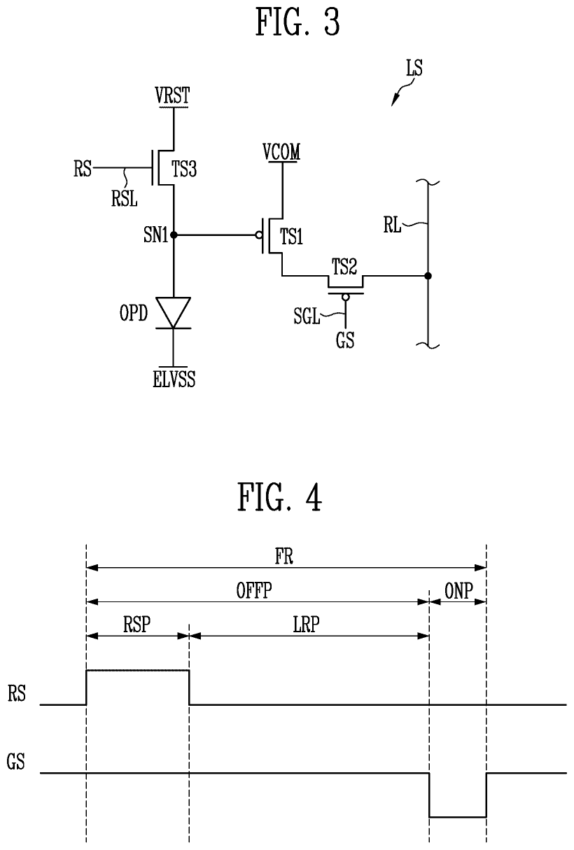

FIG. 4 is a timing diagram illustrating a method of driving the light sensor shown in FIG. 3 according to some embodiments of the present disclosure.

Referring to FIGS. 4 and 3 together, one frame FR may include a sensing on period ONP in which the sensing gate signal GS has an activation level and a sensing off period OFFP in which the sensing gate signal GS has a deactivation level. For example, as shown in FIG. 3, when the second sensing transistor TS2 is a PMOS transistor, the activation level of the sensing gate signal GS may be a low voltage level, and the deactivation level of the sensing gate signal GS may be a high voltage level.

The reset signal RS may have an activation period (e.g., a reset period RSP) in the sensing off period OFFP in which the sensing gate signal GS has the deactivation level. In addition, the reset signal RS may have a deactivation period (e.g., a light receiving period LRP) in the sensing off period OFFP. For example, the activation period may be a period with an activation level, and the deactivation period may be a period with a deactivation level.

For example, as shown in FIG. 3, when the third sensing transistor TS3 is an NMOS transistor, an activation level of the reset signal RS may be a high voltage level, and a deactivation level may be a low voltage level.

In some embodiments, the reset period RSP may be at a start of the sensing off period OFFP, but the disclosure is not limited thereto.

For example, in the reset period RSP, the reset signal RS may have the activation level and the sensing gate signal GS may have the deactivation level. Accordingly, the third sensing transistor TS3 may be turned on and the second sensing transistor TS2 may be turned off. In addition, the reset voltage VRST may be applied to the first sensing node SN1. That is, the first sensing node SN1 and the first electrode of the light receiving element OPD may be initialized.

For example, in the light receiving period LRP, the reset signal RS and the sensing gate signal GS may have the deactivation level. Accordingly, the second sensing transistor TS2 and the third sensing transistor TS3 may be turned off. In addition, when light is applied, the light receiving element OPD may generate a current in a direction of the first sensing node SN1, and a voltage of the first sensing node SN1 may be decreased. Accordingly, an intensity of the sensing signal generated in the sensing on period ONP to be described later may be changed.

For example, in the sensing on period ONP, the reset signal RS may have the deactivation level and the sensing gate signal GS may have the activation level. Accordingly, the second sensing transistor TS2 may be turned on and the third sensing transistor TS3 may be turned off. In addition, the first sensing transistor TS1 may generate a sensing signal corresponding to a gate-source voltage. The sensing signal may be applied to the readout circuit through the readout line RL.

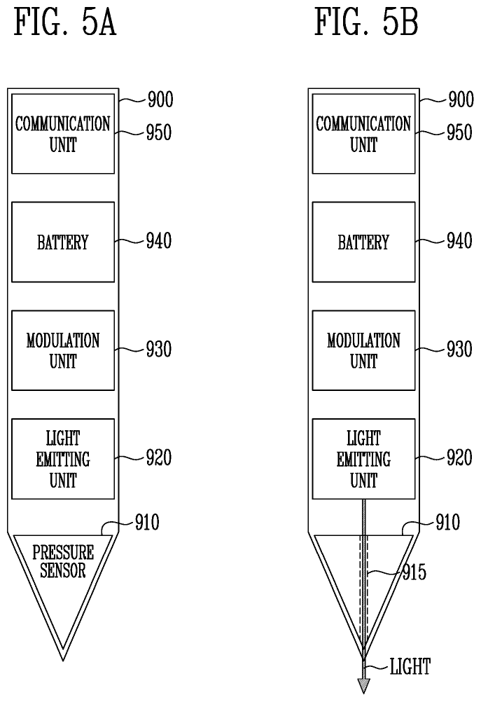

FIGS. 5A and 5B are drawings illustrating a touch pen according to some embodiments of the present disclosure. Referring to FIG. 5A, the touch pen 900 according to some embodiments of the disclosure may include a pressure sensor 910, a light emitting unit 920, and a modulation unit 930. According to some embodiments, the touch pen 900 may further include a battery 940 and a communication unit 950. In some embodiments, the touch pen 900 may have a cylindrical body and a cone-shaped protrusion at an end of the cylindrical body.

The pressure sensor 910 may sense a physical pressure applied to a first end of the touch pen 900. To this end, the pressure sensor 910 may be positioned near the first end of the touch pen 900.

The light emitting unit 920 may generate light. The light generated by the light emitting unit 920 may be emitted to the outside through the first end of the touch pen 900. To this end, as shown in a dotted line in FIG. 5B, the pressure sensor 910 may include a light path for emitting the light generated from the light emitting unit 920 to the first end of the touch pen 900.

The modulation unit 930 may control the light emitting unit 920 to change a characteristic of the light emitted from the light emitting unit 920. To this end, the modulation unit 930 may generate a light control signal for changing the characteristic of the light generated from the light emitting unit 920.

For example, the battery 940 may supply a power voltage to components included in the touch pen 900. In addition, the communication unit 950 may include a display device or a communication module for communicating with the display device. For example, the communication unit 950 may include a communication module using a Bluetooth protocol, a WiFi protocol, a Zigbee protocol, or various other suitable wireless communication protocols. In some other embodiments, the communication unit 950 may include a wired communication module. In some embodiments, the communication unit 950 may communicate with the driving controller 200 shown in FIG. 1, or may communicate with the touch processor 800 shown in FIG. 1. In this case, the communication unit 950 may generate an external control signal that controls an operation of the modulation unit 930 based on a result of communicating with the display device. The modulation unit 930 may generate the light control signal in response to the external control signal.

As another example, the communication unit 950 may communicate with a processor connected to the display device, for example, a microprocessor, a central processing unit, an application processor, or the like. For example, the communication unit 950 may generate an external control signal that controls the operation of the modulation unit 930 based on a result of communicating with the processor (e.g., based on a signal received from the processor or based on signals exchanged between the communication unit 950 and the processor). The modulation unit 930 may generate the light control signal in response to the external control signal.

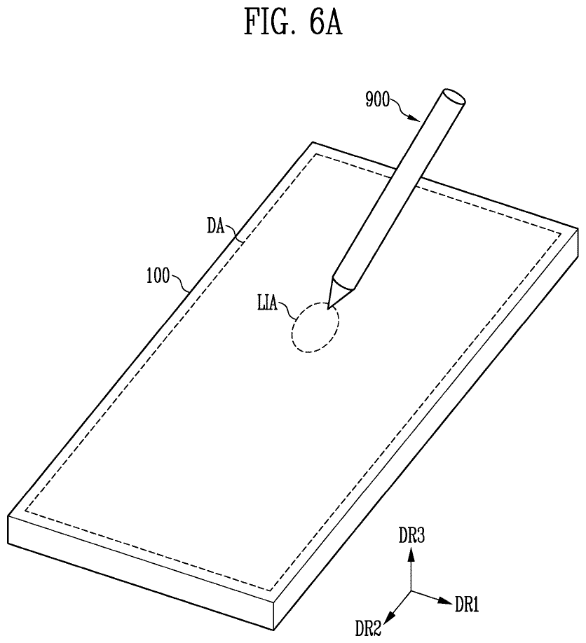

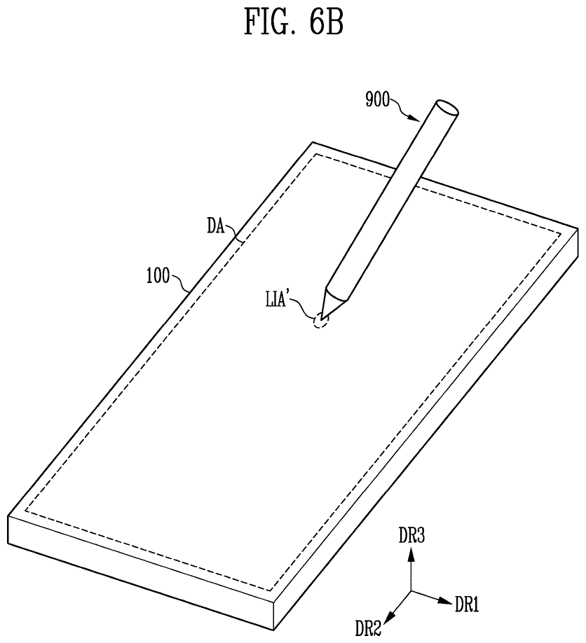

FIGS. 6A and 6B are drawings illustrating an operation of a display device and a touch pen according to some embodiments of the present disclosure. In FIGS. 6A and 6B, only the display panel 100 among the components of the display device is shown for convenience. Referring to FIGS. 6A and 6B, the touch pen 900 may generate light near the display area DA of the display panel 100. In this case, a portion of the light sensors included in the display panel may sense the light generated by the touch pen 900.

For example, the touch pen 900 may generate light that is relatively stronger than light near the display panel 100 or the light generated by the light emitting elements in the sub-pixel included in the display panel. For example, among the light sensors included in the display panel, an intensity of the light sensed by the light sensors positioned near the first end of the touch pen 900 may be greater than a first reference value (e.g., a set reference value or a reference value that is determined in advance). Therefore, among the light sensors included in the display panel 100, light sensors that sense the light of the intensity greater than the first reference value may be determined to be included in an area where the light generated from the touch pen 900 is irradiated, that is, a light irradiation area LIA.

Referring to FIGS. 6A and 6B, a size of the light irradiation area LIA may vary according to a relative position of the touch pen 900 and the display panel 100. A size of the light irradiation area LIA generated when the touch pen 900 is positioned relatively far from the display panel 100 As shown in FIG. 6A may be greater than a size of a light irradiation area LIA′ generated when the touch pen 900 is positioned relatively close to the display panel 100 as shown in FIG. 6B.

Therefore, when the touch pen 900 directly contacts the display panel 100, that is, the size of the light irradiation area generated when a touch occurs by the touch pen 900 may be the smallest. According to some embodiments of the disclosure, when the size of the light irradiation area is less than a set area (e.g., a preset or predetermined area), it may be determined that a touch of the display panel 100 by the touch pen 900 occurs, and when the size of the light irradiation area is equal to or greater than the predetermined area, it may be determined that the touch of the display panel 100 by the touch pen 900 does not occur.

However, when using this method, a problem that the size of the light irradiation area changes due to noise from external light may occur. That is, determination of whether or not a touch occurs may change according to presence or absence of external light. Accordingly, according to some other embodiments of the disclosure, a characteristic of the light generated by the light emitting unit 920 is changed based on a pressure sensed by the pressure sensor 910 of the touch pen 900. The touch processor 800 of the display device may determine whether a touch of the display panel 100 by the touch pen 900 occurs based on the characteristic of the sensed light. Accordingly, touch presence or absence of the display device by the touch pen 900 may be more accurately sensed.

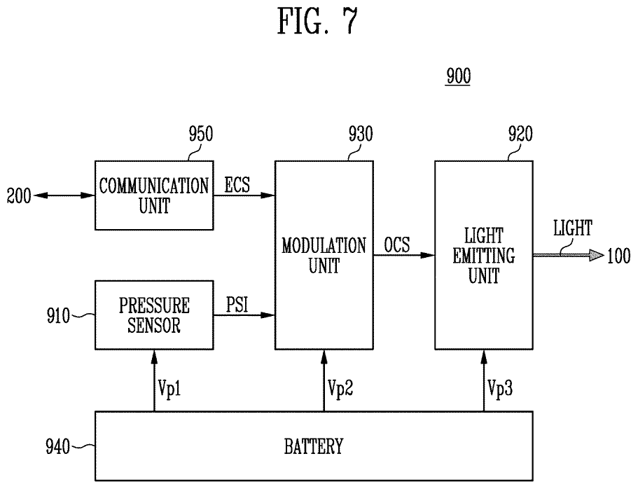

FIG. 7 is a block diagram illustrating an operation of the touch pen shown in FIGS. 5A and 5B according to some embodiments of the present disclosure.

Referring to FIG. 7, the touch pen 900 may include the pressure sensor 910, the light emitting unit 920, and the modulation unit 930 as described above with reference to FIGS. 5A and 5B. According to some embodiments, the touch pen 900 may further include the battery 940 and the communication unit 950.

The pressure sensor 910 may sense a physical pressure applied to the first end of the touch pen 900 and may generate pressure sensing information PSI. The pressure sensing information PSI may be transmitted to the modulation unit 930.

The communication unit 950 may communicate with the driving controller 200 of the display device. However, this is merely an example, and the communication unit 950 may also communicate with a processor outside the display device, such as a microprocessor, a central processing unit, or an application processor.

In addition, the communication unit 950 may generate an external control signal ECS that controls the operation of the modulation unit 930, based on a communication result. The generated external control signal ECS may be transmitted to the modulation unit 930.

The modulation unit 930 may control light generation of the light emitting unit 920. In some embodiments, the modulation unit 930 may generate a light control signal OCS for changing a light characteristic generated by the light emitting unit 920, based on the pressure sensing information PSI. Additionally, the modulation unit 930 may generate the light control signal OCS in response to the external control signal ECS received from the communication unit 950.

The light emitting unit 920 may generate the light based on the light control signal OCS received from the modulation unit 930. For example, the light emitting unit 920 may generate the light that matches an intensity and a blink frequency specified by the light control signal OCS. In some embodiments, the light emitting unit 920 may generate the light to have a pattern indicating a code specified by the light control signal OCS. The light generated by the light emitting unit 920 may be transmitted to the display panel 100 and sensed by the light sensors in the light irradiation area LIA.

For example, the battery 940 may generate power voltages Vp1, Vp2, and Vp3 respectively supplied to the pressure sensor 910, the modulation unit 930, and the light emitting unit 920. In some embodiments, the battery 940 may also generate a power voltage supplied to the communication unit 950.

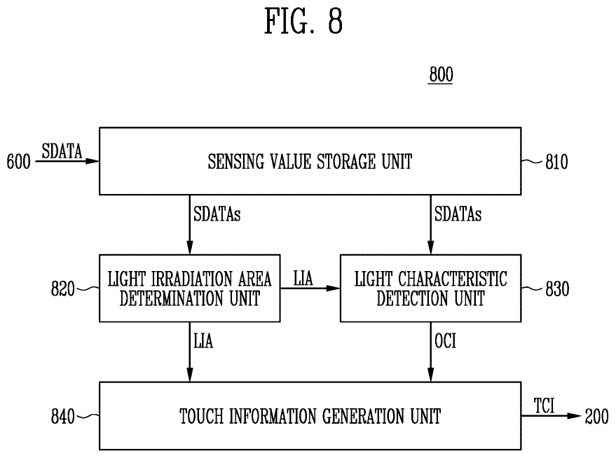

FIG. 8 is a block diagram illustrating a touch processor of FIG. 1.

Referring to FIG. 8, the touch processor 800 may include a sensing value storage unit 810, a light irradiation area determination unit 820, a light characteristic detection unit 830, and a touch information generation unit 840.

The sensing value storage unit 810 may store the sensing data SDATA received from the readout circuit 600. In FIG. 8, the sensing data SDATA may indicate a value corresponding to an intensity of light sensed by a plurality of light sensors included in the display panel 100. For example, the sensing value storage unit 810 may store values corresponding to an intensity of light sensed by each of all light sensors included in the display panel 100 at a time point (e.g., a point in time). As another example, the sensing value storage unit 810 may store values corresponding to the intensity of the light sensed by each of all light sensors included in the display panel 100 during a certain period of time.

The light irradiation area determination unit 820 may receive a plurality of sensing data SDATAs from the sensing value storage unit 810. As an example, the plurality of sensing data SDATAs may include the values corresponding to the intensity of the light sensed by each of the light sensors included in the display panel 100 at a time point. As another example, the plurality of sensing data SDATAs may include the values corresponding to the intensity of the light sensed by each of the light sensors included in the display panel 100 during a period of time. The light irradiation area determination unit 820 may determine the light irradiation area LIA, based on the plurality of sensing data SDATAs. Information on the determined light irradiation area LIA may be transmitted to a light characteristic detection unit OCI or the touch information generation unit 840.

The light characteristic detection unit 830 may receive the plurality of sensing data SDATAs from the sensing value storage unit 810 and receive the information on the light irradiation area LIA from the light irradiation area determination unit 820. The light characteristic detection unit 830 may generate the light characteristic information OCI, based on the plurality of sensing data SDATAs and the light irradiation area LIA. In some embodiments, the light characteristic information OCI may include information on an intensity of light irradiated in the light irradiation area LIA. In some embodiments, the light characteristic information OCI may include information on a blink frequency of the light irradiated in the light irradiation area LIA. In some embodiments, the light characteristic information OCI may include a code corresponding to a blink pattern of the light irradiated in the light irradiation area LIA. In some embodiments, the light characteristic information OCI may include position information corresponding to a light sensor detecting light of the strongest intensity in the light irradiation area LIA.

The touch information generation unit 840 may receive the light irradiation area LIA from the light irradiation area determination unit 820 and may receive the light characteristic information OCI from the light characteristic detection unit 830. The touch information generation unit 840 may generate touch information TCI, based on the light irradiation area LIA and the light characteristic information OCI. The touch information TCI may be transmitted to the driving controller 200. However, this is merely an example, and the touch information TCI may also be transmitted to a processor outside the display device, such as a microprocessor, a central processing unit, an application processor, or the like.

In some embodiments, the touch information TCI may include information indicating whether the touch pen 900 touches the display panel 100. In some embodiments, the touch information TCI may include information indicating a touch position of the touch pen 900. In some embodiments, the touch information TCI may include information on the pen pressure of the touch pen 900. In some embodiments, the touch information TCI may include information on a degree to which the touch pen 900 is tilted.

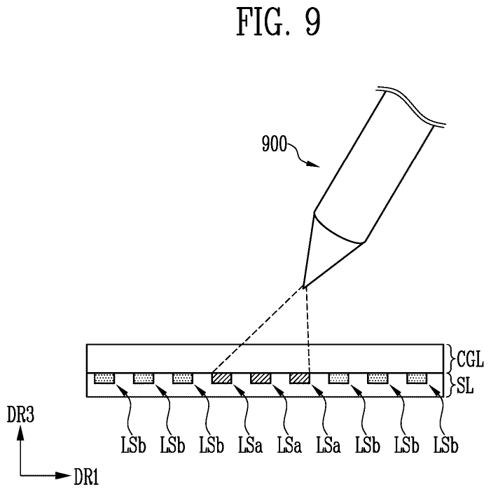

FIG. 9 is a drawing illustrating a sensor included in the light irradiation area according to some embodiments of the present disclosure.

Referring to FIG. 9, the display panel may include a sensor layer SL and a cover glass layer CGL on the sensor layer SL. For convenience of discussion, layers other than the cover glass layer CGL and the sensor layer SL of the display panel are omitted in FIG. 9. The sensor layer SL includes a plurality of light sensors.

In FIG. 9, an intensity of light sensed by first sensors LSa positioned close to the first end of the touch pen 900 may be equal to or greater than a first reference value (e.g., preset or predetermined first reference value). That is, the light sensors LSa of which an intensity of sensed light is equal to or greater than the predetermined first reference value may be determined as sensors included in the light irradiation area.

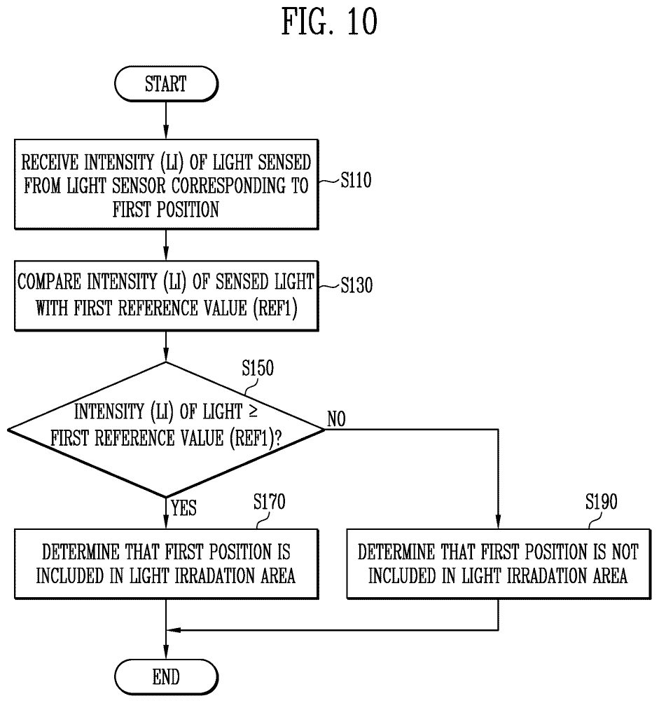

On the other hand, an intensity of light sensed by second sensors LSb positioned apart from the first end of the touch pen 900 may be less than the first reference value. That is, the light sensors LSb of which an intensity of sensed light is less than the first reference value may be determined as sensors which are not included in the light irradiation area. This operation may be performed by the light irradiation area determination unit 820 of FIG. 8. An operation of the light irradiation area determination unit 820 is described in more detail below with reference to FIG. 10.

FIG. 10 is a flowchart illustrating an operation of the display device that determines whether a light is sensed in a light irradiation area according to some embodiments of the present disclosure. For example, steps S110 to S190 of FIG. 10 may be performed by the light irradiation area determination unit 820 of FIG. 8.

Referring to FIG. 10, a method of operating the display device that determines the light irradiation area includes receiving an intensity LI of light sensed from a light sensor corresponding to a first position (S110), comparing the intensity LI of the sensed light with a first reference value (e.g., a preset or predetermined first reference value) REF1 (S130), determining whether the intensity LI of the light is equal to or greater than the first reference value REF1 (S150), when the intensity LI of the light is equal to or greater than the first reference value REF1 (S150: Yes), determining that the first position is included in a light irradiation area (S170), and when the intensity LI of the light is less than the first reference value REF1 (S150: No), determining that the first position is not included in the light irradiation area (S190).

In step S110, the sensing data SDATA corresponding to the light sensor LS of the first position is transmitted from the sensing value storage unit 810 to the light irradiation area determination unit 820. The sensing data SDATA may include information on the intensity LI of the light. In step S130, the light irradiation area determination unit 820 compares an appropriately determined first reference value REF1 with the intensity LI of the sensed light. The first reference value REF1 may have a value higher than an intensity of typical outdoor light and lower than a minimum intensity of the light generated by the light emitting unit 920 of the touch pen 900. Therefore, when the intensity LI of the light is equal to or greater than the first reference value REF1 (S150: Yes), it may be determined that light generated from the touch pen 900 is irradiated to a light sensor of a corresponding position. Therefore, in this case, the light irradiation area determination unit 820 may determine that the first position is included in the light irradiation area LIA.

On the other hand, when the intensity LI of the light is less than the first reference value REF1 (S150: No), it may be determined that the light generated from the touch pen 900 is not irradiated to the light sensor of the corresponding position. Therefore, in this case, the light irradiation area determination unit 820 may determine that the first position is not included in the light irradiation area LIA.

For example, steps S110 to S190 may be performed on the sensing data SDATA generated from one light sensor. That is, by repeatedly performing steps of FIG. 10 on the sensing data SDATAs respectively generated by all light sensors included in the display panel 100, positions included in the light irradiation area LIA may be determined. By merging the positions included in the light irradiation area LIA, the light irradiation area LIA may be finally determined.

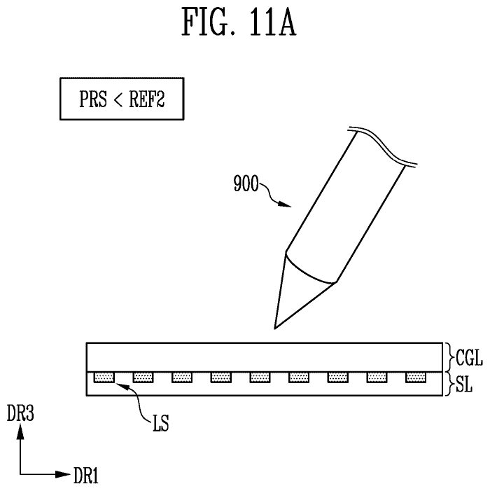

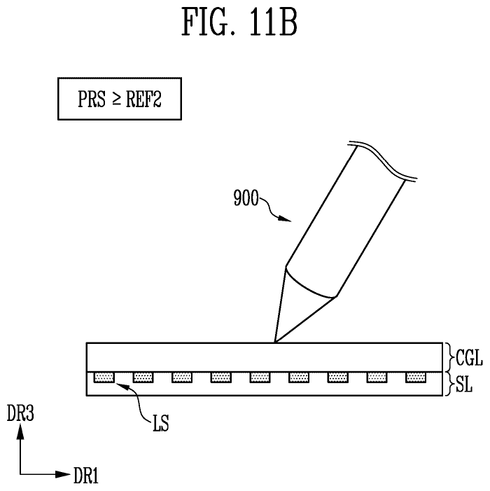

FIGS. 11A and 11B are drawings illustrating a pressure change according to touch presence or absence of the touch pen according to some embodiments of the present disclosure.

Referring to FIG. 11A, the touch pen 900 is not in contact with the cover glass layer CGL of the display panel 100. In this case, because a pressure is not applied to the first end of the touch pen 900, a pressure PRS sensed by the pressure sensor 910 may be less than a second reference value (e.g., a preset or predetermined second reference value) REF2.

For example, referring to FIG. 11B, the touch pen 900 is in contact with the cover glass layer CGL of the display panel 100. In this case, because a pressure equal to or greater than a set value is applied to the first end of the touch pen 900, the pressure PRS sensed by the pressure sensor 910 may be equal to or greater than the second reference value REF2.

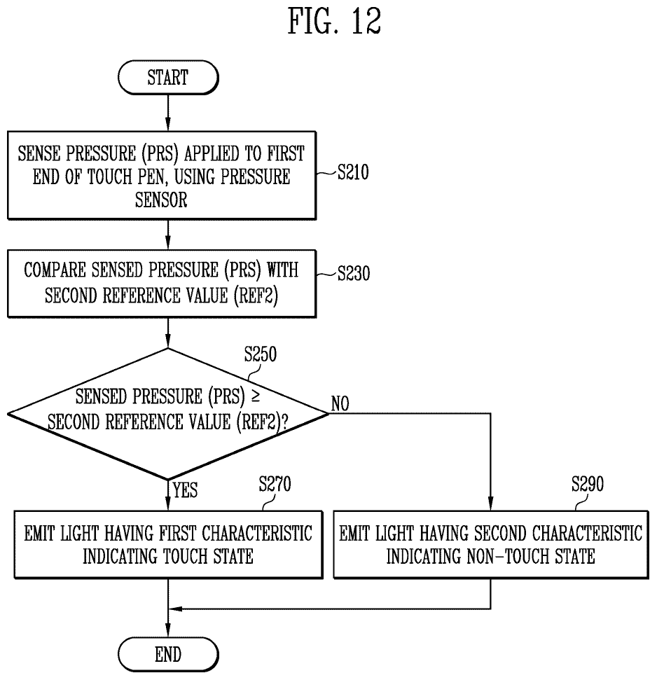

As described above, based on a size of the pressure PRS sensed by the pressure sensor 910, it may be determined whether the touch pen 900 touches the display panel 100. Hereinafter, with reference to FIG. 12, an operation of the touch pen 900 that determines a characteristic of light generated based on a size of the pressure PRS sensed by the pressure sensor 910 is described.

FIG. 12 is a flowchart illustrating an operation of the touch pen that determines a light characteristic based on touch presence or absence according to some embodiments of the present disclosure. Referring to FIG. 12, a method of operating a touch pen according to some embodiments of the disclosure includes sensing a pressure PRS applied to a first end of a touch pen using a pressure sensor (S210), comparing the sensed pressure PRS with a second reference value REF2 (S230), determining whether the sensed pressure PRS is equal to or greater than the second reference value REF2 (S250), when the sensed pressure PRS is equal to or greater than the second reference value REF2 (S250: Yes), emitting light having a first characteristic indicating a touch state (S270), and when the sensed pressure PRS is less than the second reference value REF2 (S250: No), emitting light having a second characteristic indicating a non-touch state.

Step S210 may be performed by the pressure sensor 910 of the touch pen 900. The pressure sensor 910 may sense the pressure PRS applied to the first end of the touch pen and transmit pressure sensing information PSI including information on the sensed pressure PRS to the modulation unit 930.

Step S230 may be performed by the modulation unit 930 of the touch pen 900. The modulation unit 930 receives the pressure sensing information PSI and compares the sensed pressure PRS with the second reference value REF2.

When the sensed pressure PRS is equal to or greater than the second reference value REF2 (S250: Yes), the modulation unit 930 transmits the light control signal OCS that controls the light having the first characteristic indicating the touch state of the touch pen to be emitted to the light emitting unit 920. The light emitting unit 920 generates the light having the first characteristic, based on the light control signal OCS.

When the sensed pressure PRS is less than the second reference value REF2 (S250: No), the modulation unit 930 transmits the light control signal OCS that controls the light having the second characteristic indicating the non-touch state of the touch pen to be emitted to the light emitting unit 920. The light emitting unit 920 generates the light having the second characteristic, based on the light control signal OCS.

In some embodiments, the first characteristic and the second characteristic described above may be distinguished according to the intensity of the light. For example, in the touch state, the touch pen 900 may emit light having a relatively high intensity. In addition, in the non-touch state, the touch pen 900 may emit light having a relatively low intensity. In either case, the light emitted by the touch pen 900 may have an intensity greater than the first reference value REF1 described with reference to FIG. 10.

In some other embodiments, the first characteristic and the second characteristic described above may be distinguished according to a blink frequency of the light. For example, in the touch state, the touch pen 900 may emit light having a relatively high blink frequency. For example, in the touch state, the touch pen 900 may emit light having a blink frequency of about 500 Hz or more. In addition, in the non-touch state, the touch pen 900 may emit light having a relatively low blink frequency. For example, in the non-touch state, the touch pen 900 may emit light having a blink frequency of about 100 Hz or less.

In still another embodiment, the first characteristic and the second characteristic described above may be distinguished by a code corresponding to a blink pattern of the light irradiated in the light irradiation area LIA. For example, it is assumed that when light is emitted during a predetermined period, a code corresponding to a corresponding period is defined as “1”, and when light is not emitted during a predetermined period, a code corresponding to the corresponding period is defined as “0”. For example, in the touch state, the touch pen 900 may repeatedly generate light corresponding to “1010”, and in the non-touch state, the touch pen 900 may repeatedly generate light corresponding to “1110”. In this case, based on a pattern in which light is emitted or is not emitted during four periods, information indicating whether the touch pen 900 is in the touch state may be reflected in the emitted light.

However, the above embodiments are merely examples, and various other characteristics may be reflected in the light to distinguish the touch state or non-touch state of the touch pen. Therefore, the touch processor 800 of the display device may detect the above-described characteristic from the light sensed in the irradiation area, and determine whether the touch pen 900 touches the display panel 100 therefrom.

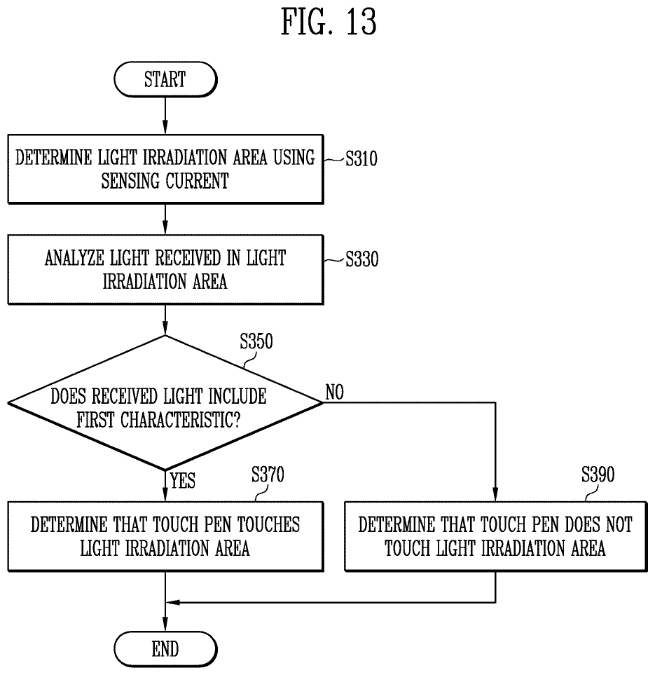

FIG. 13 is a flowchart illustrating an operation of the display device that determines touch presence or absence of the touch pen based on a light characteristic according to some embodiments of the present disclosure. For example, steps S310 to S390 of FIG. 13 may be performed by the touch processor 800 of FIG. 1.

Referring to FIG. 13, a method of operating a display device that determines touch presence or absence of a touch pen based on a light characteristic includes determining a light irradiation area using a sensing current (S310), analyzing light received in the light irradiation area (S330), determining whether the received light includes a first characteristic (S350), when the received light includes the first characteristic (S350: Yes), determining that the touch pen touches the light irradiation area (S370), and when the received light does not include the first characteristic (S350: No), determining that the touch pen does not touch the light irradiation area (S390).

Step S310 may be performed by the light irradiation area determination unit 820 of FIG. 8. As described with reference to FIG. 10, the light irradiation area determination unit 820 may determine the light irradiation area LIA by repeatedly performing steps of FIG. 10 on the sensing data SDATAs respectively generated by all light sensors included in the display panel 100.

Step S330 may be performed by the light characteristic detection unit 830 of FIG. 8. The light characteristic detection unit 830 may generate the light characteristic information OCI, based on the plurality of sensing data SDATAs and the light irradiation area LIA. In some embodiments, the light characteristic information OCI may include information on the intensity of the light irradiated in the light irradiation area LIA. In some embodiments, the light characteristic information OCI may include information on a blink frequency of the light irradiated in the light irradiation area LIA. In some embodiments, the light characteristic information OCI may include a code corresponding to a blink pattern of the light irradiated in the light irradiation area LIA.

Subsequent steps S350, S370, and S390 may be performed by the touch information generation unit 840 of FIG. 8. The touch information generation unit 840 may determine whether the light received in the light irradiation area includes the first characteristic, based on the light characteristic information OCI received from the light characteristic detection unit 830.

As described above with reference to FIG. 12, the first characteristic and the second characteristic described above may be distinguished according to the intensity of the light. For example, in the touch state, the touch pen 900 may emit light having a relatively high intensity. In addition, in the non-touch state, the touch pen 900 may emit light having a relatively low intensity. When the intensity of the received light is light of a relatively high intensity (S350: Yes), the touch information generation unit 840 determines that the touch pen touches the light irradiation area (S370). For example, when the intensity of the received light is light of a relatively low intensity (S350: No), the touch information generation unit 840 determines that the touch pen does not touch the light irradiated area (S390).

In some other embodiments, the first characteristic and the second characteristic described above may be distinguished according to (e.g., distinguished from each other by) the blink frequency of the light. For example, in the touch state, the touch pen 900 may emit light having a relatively high blink frequency, and in the non-touch state, the touch pen 900 may emit light having a relatively low blink frequency. When the blink frequency of the received light is relatively high (S350: Yes), the touch information generation unit 840 determines that the touch pen touches the light irradiated area (S370). For example, when the blink frequency of the received light is relatively low (S350: No), the touch information generation unit 840 determines that the touch pen does not touch the light irradiated area (S390).

In still another embodiment, the first characteristic and the second characteristic described above may be distinguished by the code corresponding to the blink pattern of the light irradiated in the light irradiation area LIA. In the example described with reference to FIG. 12, in the touch state, the touch pen 900 may repeatedly generate light corresponding to “1010”, and in the non-touch state, the touch pen 900 may repeatedly generate light corresponding to “1110”. When the light characteristic information OCI received by the touch information generation unit 840 includes a code of “1010” (S350: Yes), the touch information generation unit 840 determines that the touch pen touches the light irradiation area (S370). For example, when the light characteristic information OCI received by the touch information generation unit 840 includes the code of “1110” (S350: No), the touch information generation unit 840 determines that the touch pen does not touch the light irradiation area (S390).

As described above, according to the touch pen and the display device according to embodiments of the disclosure, information indicating touch presence or absence of the touch pen may be included in the light generated by the touch pen. The display device may read information on touch presence or absence of the touch pen from the sensed light.

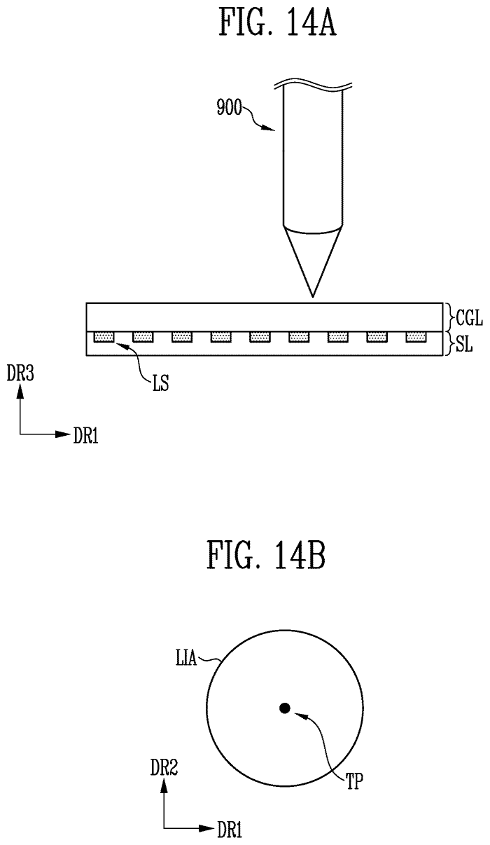

FIGS. 14A and 14B are drawings illustrating a characteristics of the light irradiation area and the touch position when the touch pen is not tilted according to some embodiments of the present disclosure.

As described above, the touch information generation unit 840 may receive the light characteristic information OCI from the light characteristic detection unit 830. In some embodiments, the light characteristic information OCI may include position information corresponding to the light sensor that detected light of the strongest intensity in the light irradiation area LIA. The touch information generation unit 840 may determine a touch position TP, based on a position corresponding to the light sensor that detected the light of strongest intensity in the light irradiation area LIA. In some embodiments, the touch position TP may be the same as the position corresponding to the light sensor that detected the light of the strongest intensity in the light irradiation area LIA.

In some embodiments, the touch position TP may be different from the position corresponding to the light sensor that detected the light of the strongest intensity in the light irradiation area LIA. The touch information generation unit 840 may calculate the touch position TP by partially correcting the position corresponding to the light sensor that detected the light of the strongest intensity in the light irradiation area LIA, based on a shape of the light irradiation area LIA.

Referring to FIGS. 14A and 14B, when the touch pen 900 and the display panel 100 are perpendicular to each other, the light irradiation area LIA determined by the light irradiation area determination unit 820 may be circular. In addition, when the touch pen 900 and the display panel 100 are perpendicular to each other, the touch position TP determined by the touch information generation unit 840 may be a center of the light irradiation area LIA.

When the light irradiation area LIA received from the light irradiation area determination unit 820 has a circular shape and the determined touch position TP is positioned at the center of the light irradiation area LIA, the touch information generation unit 840 may determine that the touch pen 900 is not tilted but is perpendicular to the display panel 100.

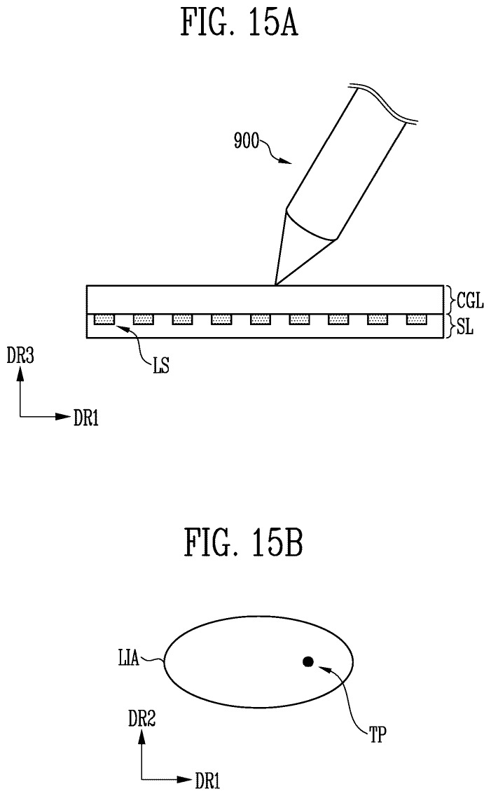

FIGS. 15A and 15B are drawings illustrating a characteristic of the light irradiation area and the touch position when the touch pen is tilted according to some embodiments of the present disclosure.

Referring to FIGS. 15A and 15B, when the touch pen 900 is somewhat tilted with respect to the display panel 100 (see, e.g., FIG. 1) (e.g., when an axial direction of the touch pen 900 is not perpendicular to a surface of the display panel 100), the light irradiation area LIA determined by the light irradiation area determination unit 820 may be an elliptical shape (e.g., an oval or an ellipse). In addition, a direction in which the touch pen 900 is tilted may be a direction of a long axis of an ellipse which is a shape of the light irradiation area LIA.

In addition, when the touch pen 900 is somewhat tilted with respect to the display panel 100, the touch position TP determined by the touch information generation unit 840 may be a position that is out of the center (e.g., not in the center) of the light irradiation area LIA. At this time, the touch position TP may be positioned on the long axis of the ellipse which is the shape of the light irradiation area LIA.

For example, according to a degree to which (e.g., angle at which) the touch pen 900 is tilted with respect to the display panel 100, the shape of the ellipse and the touch position TP may vary. For example, as the degree to which the touch pen 900 is tilted with respect to the display panel 100 increases, a length of the long axis of the ellipse may be relatively long compared to a short axis. In addition, as the degree to which the touch pen 900 is tilted with respect to the display panel 100 increases, the touch position TP is positioned closer to an edge of the ellipse formed by the light irradiation area LIA.

For example, as the degree to which the touch pen 900 is tilted with respect to the display panel 100 decreases, the shape of the light irradiation area LIA may become closer to a circular shape. In addition, as the degree to which the touch pen 900 is tilted with respect to the display panel 100 decreases, the touch position TP is positioned closer to the center of the light irradiation area LIA.

The touch information generation unit 840 may determine a tilt value indicating the degree to which the touch pen 900 is tilted based on the shape of the light irradiation area LIA and the touch position TP. The determined tilt value may be included in the touch information TCI.

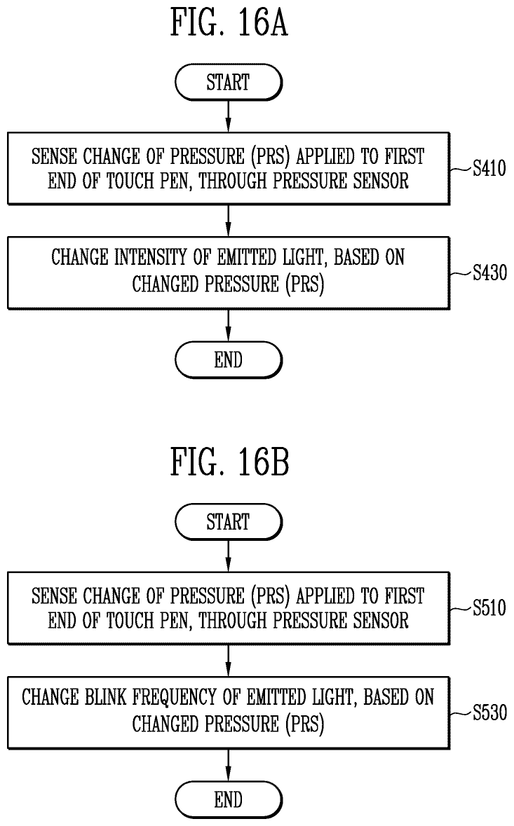

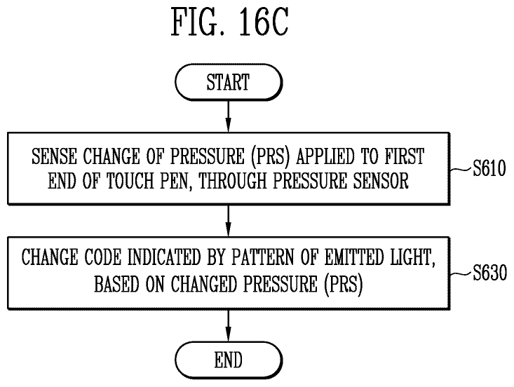

FIGS. 16A, 16B, and 16C are flowcharts illustrating embodiments in which information indicating a pressure sensed by a pressure sensor is included in emitted light according to some embodiments of the present disclosure. The touch pen 900 according to some embodiments of the disclosure may sense a pen pressure through the pressure sensor 910 and generate light by reflecting information on the sensed pen pressure.

Referring to FIG. 16A, a method of operating a touch pen according to some embodiments of the disclosure includes sensing a change of the pressure PRS applied to the first end of the touch pen through the pressure sensor (S410), and changing an intensity of emitted light based on the changed pressure PRS (S430). Steps S410 and S430 of FIG. 16A may be performed by the modulation unit 930 of FIG. 7.

The pressure sensor 910 may sense the pressure PRS of the first end of the touch pen 900 at regular intervals and transmit the pressure sensing information PSI, which is information on the sensed pressure PRS, to the modulation unit 930.

The modulation unit 930 may detect the change of the pressure PRS applied to the first end of the touch pen 900 based on the pressure sensing information PSI input at regular intervals. When the pressure PRS changes, the modulation unit 930 may generate the light control signal OCS that controls the light emitting unit 920 to reflect the changed pressure PRS. According to some embodiments of the disclosure, the modulation unit 930 may generate the light control signal OCS that controls the light emitting unit 920 to change the intensity of the emitted light based on the changed pressure PRS. The light emitting unit 920 may generate light having an intensity corresponding to the changed pressure PRS, based on the received light control signal OCS.

For example, when the pen pressure of the touch pen 900 is divided into 64 steps, the touch pen 900 may set an intensity of light corresponding to each of the 64 steps of the pen pressure and generate light having an intensity corresponding to the sensed pen pressure. For example, an intensity of light corresponding to a minimum pen pressure may correspond to 20 percent of a maximum light intensity that the light emitting unit 920 may generate. In addition, an intensity of light corresponding to a maximum pen pressure may correspond to 100 percent of a light intensity that the light emitting unit 920 may generate.

After step S430 is performed, the touch information generation unit 840 included in the touch processor 800 of the display device may detect the pen pressure of the touch pen 900, based on intensity information of light included in the light characteristic information OCI.

For example, referring to FIG. 16B, a method of operating a touch pen according to some other embodiments of the disclosure includes sensing the change of the pressure PRS applied to the first end of the touch pen through the pressure sensor (S510), and changing the blink frequency of the emitted light, based on the changed pressure PRS (S530). Steps S510 and S530 of FIG. 16B may be performed by the modulation unit 930 of FIG. 7A.

The pressure sensor 910 may sense the pressure PRS of the first end of the touch pen 900 at regular intervals, and transmit the pressure sensing information PSI, which is information on the sensed pressure PRS, to the modulation unit 930.

The modulation unit 930 may detect the change of the pressure PRS applied to the first end of the touch pen 900, based on the pressure sensing information PSI input at regular intervals. When the pressure PRS changes, the modulation unit 930 may generate the light control signal OCS that controls the light emitting unit 920 to reflect the changed pressure PRS. According to some other embodiments of the disclosure, the modulation unit 930 may generate the light control signal OCS that controls the light emitting unit 920 to change the blink frequency of the emitted light, based on the changed pressure PRS. The light emitting unit 920 may generate light having the blink frequency corresponding to the changed pressure PRS, based on the received light control signal OCS.

For example, when the pen pressure of the touch pen 900 is divided into 64 steps, the touch pen 900 may set a blink frequency of light corresponding to each of the 64 steps of the pen pressure and generate light having a blink frequency corresponding to the sensed pen pressure. For example, a blink frequency corresponding to a minimum pen pressure may be about 100 Hz, and a blink frequency corresponding to a maximum pen pressure may be about 1000 Hz. When the sensed pen pressure is the minimum pen pressure, the light emitting unit 920 may generate light that blinks about 100 times per second. When the sensed pen pressure is the maximum pen pressure, the light emitting unit 920 may generate light that blinks about 1000 times per second.

After step S530 is performed, the touch information generation unit 840 included in the touch processor 800 of the display device may detect the pen pressure of the touch pen 900, based on blink frequency information of light included in the light characteristic information OCI.

For example, referring to FIG. 16C, a method of operating a touch pen according to another embodiment of the disclosure includes sensing the change of the pressure PRS applied to the first end of the touch pen through the pressure sensor (S610), and changing a code indicated by a pattern of emitted light, based on the changed pressure PRS (S630). Steps S610 and S630 of FIG. 16C may be performed by the modulation unit 930 of FIG. 7A.

The pressure sensor 910 may sense the pressure PRS of the first end of the touch pen 900 at regular intervals, and transmit the pressure sensing information PSI, which is information on the sensed pressure PRS, to the modulation unit 930.

The modulation unit 930 may detect the change of the pressure PRS applied to the first end of the touch pen 900, based on the pressure sensing information PSI input at regular intervals. When the pressure PRS changes, the modulation unit 930 may generate the light control signal OCS that controls the light emitting unit 920 to reflect the changed pressure PRS. According to some other embodiments of the disclosure, the modulation unit 930 may generate the light control signal OCS that controls the light emitting unit 920 to change the code indicated by the blink pattern, based on the changed pressure PRS. The light emitting unit 920 may generate light having the blink pattern indicating the code corresponding to the changed pressure PRS, based on the received light control signal OCS.

For example, when the pen pressure of the touch pen 900 is divided into 64 steps, the pen pressure may be divided into 6 bits of code. The touch pen 900 may set a blink pattern indicating a code corresponding to each of the 64 steps of the pen pressure, and generate light having a blink pattern corresponding to the sensed pen pressure. For example, a code corresponding to a minimum pen pressure may be “000000”, and a code corresponding to a maximum pen pressure may be “111111”.

For example, a blink pattern corresponding to the code of “000000” may correspond to continuously generating light corresponding to 20 percent of a maximum light intensity that the light emitting unit 920 may generate during one pattern period.

For example, a blink pattern corresponding to the code of “111111” may correspond to continuously generating light corresponding to 50 percent of the maximum light intensity that the light emitting unit 920 may generate during one pattern period.

For example, a blink pattern corresponding to a code of “101010” may correspond to alternately generating light corresponding to 50 percent of the maximum light intensity that the light emitting unit 920 may generate during one pattern period and light corresponding to 20 percent of the maximum light intensity, generating the light corresponding to 50 percent of the maximum light intensity three times and generating the light corresponding to 20 percent of the maximum light intensity three times.

For example, in order to distinguish one pattern from another pattern, the touch pen 900 may generate light corresponding to 100 percent of the maximum light intensity that the light emitting unit 920 may generate during a certain period between a pattern and another pattern.

After step S630 is performed, the touch information generation unit 840 (see, e.g., FIG. 8) included in the touch processor 800 of the display device may detect the pen pressure of the touch pen 900, based on the code corresponding to the blink pattern of the light irradiated in the light irradiation area LIA included in the light characteristic information OCI.

For example, according to embodiments of the disclosure, the pen pressure may be distinguished by combining at least two of the embodiments shown in FIGS. 16A to 16C. In some embodiments, the pen pressure may be distinguished by combining the embodiments of FIGS. 16A and 16B. For example, in order to indicate the pen pressure, the intensity of the light emitted by the touch pen may be divided into 8 steps, and the blink frequency of the light emitted by the touch pen may be divided into 8 steps. In this case, 64 steps of pen pressure may be distinguished.

In some other embodiments, the pen pressure may be distinguished by combining the embodiments of FIGS. 16B and 16C. For example, a case where the blink frequency of the light emitted by the touch pen is divided into 16 steps to indicate the pen pressure, and 8 bits of code is used as a pattern of the light emitted by the touch pen is assumed. Because 16 steps of blink frequency corresponds to 4 bits, and the 8 bits of code may be used together, a total of 12 bits of pressure, that is, 4096 steps of pressure, may be distinguished. As another example, it may be seen that a combination of the embodiments of FIGS. 16A and 16C is also possible, and a combination of all of the embodiments of FIGS. 16A, 16B, and 16C is also possible.

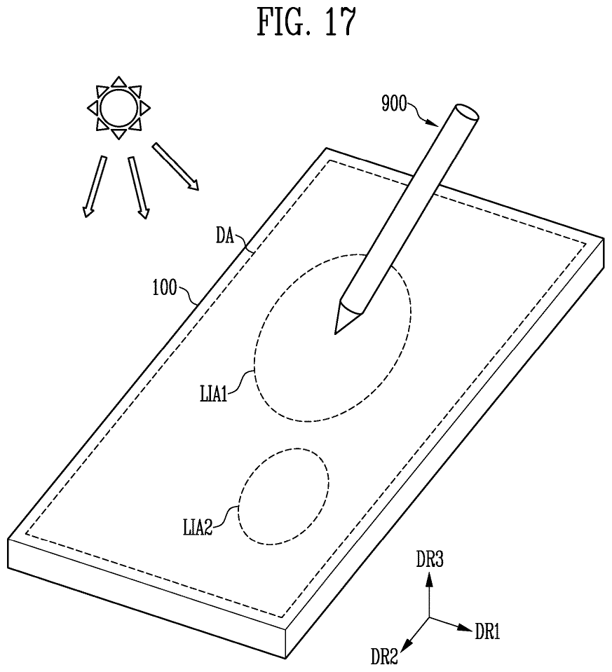

FIG. 17 is a drawing illustrating a characteristic of the light irradiation area detected when external strong light acts as noise according to some embodiments of the present disclosure.

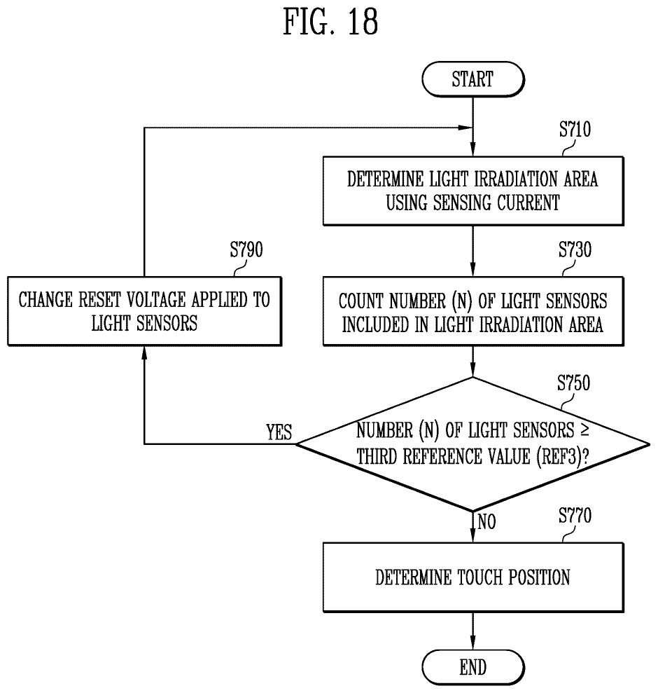

As shown in FIG. 17, when the display device is used outside during a day, strong outdoor light entering around the display panel 100 may act as noise. As described above with reference to FIG. 10, because the light irradiation area is determined based on the intensity of the light sensed by each light sensor, when strong outdoor light is irradiated on the display panel 100 as shown in FIG. 17, a first light irradiation area LIA1 and a second light irradiation area LIA2 may be determined by noise. The first and second light irradiation areas LIA1 and LIA2 may be incorrectly calculated due to noise, and in this case, sensing sensitivity of the light sensors LS may be lowered in order to account for the noise. For example, when the sensing sensitivity of the light sensors LS is lowered, the light irradiation area according to the light generated by the touch pen 900 may not be detected. Therefore, when the sensing sensitivity of the light sensors LS is lowered, the intensity of the light generated by the touch pen 900 may be selectively increased. Hereinafter, the disclosure is described with reference to FIG. 18.

FIG. 18 is a flowchart illustrating an operation of the display device for reducing noise due to external light according to some embodiments of the present disclosure.

Referring to FIG. 18, a method of operating the display device for reducing noise due to external light includes determining a light irradiation area using a sensing current (S710), counting the number N of light sensors included in the light irradiation area (S720), determining whether the number N of the counted light sensors is equal to or greater than a third reference value (e.g., a preset or predetermined third reference value) REF3 (S750), when the number N of the light sensors is equal to or greater than the third reference value REF3 (S750: Yes), changing a reset voltage supplied to the light sensors (S790), and when the number N of the light sensors is less than the third reference value REF3 (S750: No), determining a touch position TP (S770).

Step S710 may be performed by the light irradiation area determination unit 820 of the touch processor 800. That is, in step S710, light sensors that sensed light intensity equal to or greater than the first reference value REF1 are determined.

Step S730 may be performed by the touch information generation unit 840 or the light irradiation area determination unit 820 (see, e.g., FIG. 8). For example, by the touch information generation unit 840 or the light irradiation area determination unit 820, in step S730, the number N of the light sensors that sensed the light intensity equal to or greater than the first reference value REF1 may be counted.

Step S750 may also be performed by the touch information generation unit 840 or the light irradiation area determination unit 820. For example, by the touch information generation unit 840 or the light irradiation area determination unit 820, in step S730, it may be determined whether the number N of the light sensors that sensed the light intensity equal to or greater than the first reference value REF1 is equal to or greater than the predetermined third reference value REF3.

When the number N of the light sensors that sensed the light intensity equal to or greater than the first reference value REF1 is equal to or greater than the third reference value REF3 (S790: Yes), this means that the light irradiation area LIA is excessively large due to external noise. Therefore, in this case, the display device may change the reset voltage VRST supplied to each light sensor LS. In some embodiments, the sensing sensitivity of the light sensors LS may be reduced by increasing the reset voltage VRST.

In some other embodiments, instead of changing the reset voltage VRST in step S790, a length of the light receiving period LRP shown in FIG. 4 may be reduced. Accordingly, the sensing sensitivity of the light sensors LS may be reduced.

In still some other embodiments, instead of changing the reset voltage VRST or reducing the length of the light receiving period LRP in step S790, a length of the sensing on period ONP in which the sensing gate signal GS has an activation level may be reduced. Accordingly, the sensing sensitivity of the light sensors LS may be reduced.

For example, together with reducing the sensing sensitivity of the light sensors LS in step S790, increase of the intensity of the light generated by the light emitting unit 920 of the touch pen 900 may be desirable. Accordingly, the display device may communicate with the communication unit 950 of the touch pen 900. The touch pen 900 may increase the intensity of the light generated by the light emitting unit 920 based on communication with the display device.

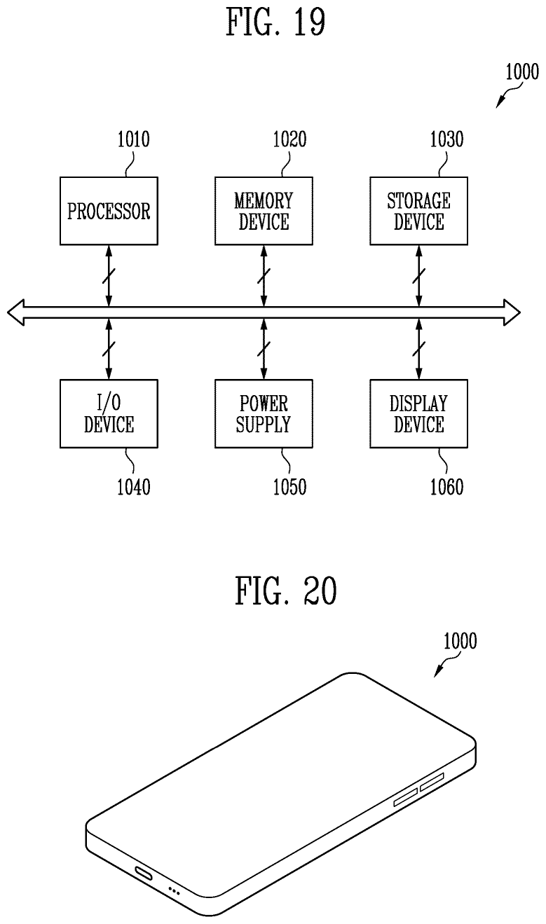

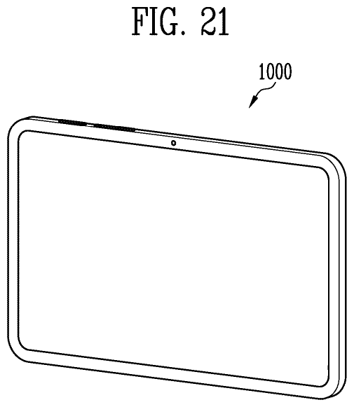

FIG. 19 is a block diagram illustrating an electronic device according to some embodiments of the present disclosure, FIG. 20 is a diagram illustrating the electronic device of FIG. 19 implemented as a smartphone according to some embodiments of the present disclosure, and FIG. 21 is a block diagram illustrating the electronic device of FIG. 19 implemented as a tablet PC according to some embodiments of the present disclosure.

Referring to FIGS. 19 to 21, the electronic device 1000 may include a processor 1010, a memory device 1020, a storage device 1030, an input/output device 1040, a power supply 1050, and a display device 1060. At this time, the display device 1060 may be the display device of FIG. 1. In addition, the electronic device 1000 may further include several ports capable of communicating with a video card, a sound card, a memory card, a USB device, or the like, or communicating with other systems. In some embodiments, as shown in FIG. 20, the electronic device 1000 may be implemented as a smart phone. In some other embodiments, as shown in FIG. 21, the electronic device 1000 may be implemented as a tablet PC. However, this is merely an example, and the electronic device 1000 is not limited thereto. For example, the electronic device 1000 may be implemented as a mobile phone, a video phone, a smart pad, a smart watch, a vehicle navigation device, a computer monitor, a notebook computer, a head mounted display device, or the like.

The processor 1010 may perform specific calculations or tasks. According to some embodiments, the processor 1010 may be a microprocessor, a central processing unit, an application processor, or the like. The processor 1010 may be connected to other components through an address bus, a control bus, a data bus, or the like. According to some embodiments, the processor 1010 may also be connected to an expansion bus, such as a peripheral component interconnect (PCI) bus.

The memory device 1020 may store data for operation of the electronic device 1000. For example, the memory device 1020 may include a non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM), and a ferroelectric random access memory (FRAM) device, a volatile memory device such as a dynamic random access memory (DRAM) device, a static random access memory (SRAM) device, and a mobile DRAM device, and/or the like.

The storage device 1030 may include a solid state drive (SSD), a hard disk drive (HDD), a CD-ROM, and the like.

The input/output device 1040 may include an input means such as a keyboard, a keypad, a touch pad, a touch screen, and a mouse, and an output means such as a speaker and a printer. According to some embodiments, the display device 1060 may be included in the input/output device 1040.

The power supply 1050 may supply power necessary for an operation of the electronic device 1000. For example, the power supply 1050 may be a power management integrated circuit (PMIC).

The display device 1060 may display an image corresponding to visual information of the electronic device 1000. For example, the display device 1060 may be an organic light emitting display device or a quantum dot light emitting display device, but is not limited thereto. The display device 1060 may be connected to other components through the buses or other communication links.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A touch pen comprising:
a light emitting unit configured to generate light for touch detection;
a pressure sensor configured to generate pressure sensing information by sensing a pen pressure; and
a modulation unit configured to determine a characteristic of the light generated by the light emitting unit, based on the pressure sensing information.

2. The touch pen of claim 1, wherein the modulation unit is configured to control the light emitting unit to generate light having a first characteristic indicating a touch state in response to a pressure indicated by the pressure sensing information being equal to or greater than a reference value, and is configured to control the light emitting unit to generate light having a second characteristic indicating a non-touch state in response to the pressure indicated by the pressure sensing information being less than the reference value.

3. The touch pen of claim 2, wherein the modulation unit is configured to control the light emitting unit to generate light of a first intensity in response to the pressure indicated by the pressure sensing information being equal to or greater than the reference value, and is configured to control the light emitting unit to generate light of a second intensity lower than the first intensity in response to the pressure indicated by the pressure sensing information being less than the reference value.

4. The touch pen of claim 2, wherein the modulation unit is configured to control the light emitting unit to generate light that blinks at a first frequency in response to the pressure indicated by the pressure sensing information being equal to or greater than the reference value, and is configured to control the light emitting unit to generate light that blinks at a second frequency lower than the first frequency in response to the pressure indicated by the pressure sensing information being less than the reference value.

5. The touch pen of claim 2, wherein the modulation unit is configured to control the light emitting unit to generate light having a first blink pattern corresponding to a first code in response to the pressure indicated by the pressure sensing information being equal to or greater than the reference value, and is configured to control the light emitting unit to generate light having a second blink pattern corresponding to a second code different from the first code in response to the pressure indicated by the pressure sensing information being less than the reference value.

6. The touch pen of claim 1, wherein in response to a change in the pressure indicated by the pressure sensing information, the modulation unit is configured to control the light emitting unit to generate light having a characteristic corresponding to the changed pressure.

7. The touch pen of claim 6, wherein the modulation unit is configured to control the light emitting unit to change an intensity of the generated light when the pressure indicated by the pressure sensing information changes.

8. The touch pen of claim 6, wherein the modulation unit is configured to control the light emitting unit to change a frequency at which the generated light blinks in response to a change in the pressure indicated by the pressure sensing information.

9. The touch pen of claim 6, wherein the modulation unit is configured to control the light emitting unit to change a code indicated by a blink pattern of the generated light in response to a change in the pressure indicated by the pressure sensing information.

10. The touch pen of claim 1, further comprising:
a communication unit configured to communicate with an external device; and
a battery configured to supply a power voltage to at least one of the light emitting unit, the pressure sensor, and the modulation unit,
wherein an intensity of the light generated by the light emitting unit is configured to change based on communication with the external device.

11. A display device comprising:
a display panel comprising a plurality of light sensors that sense light irradiated from a touch pen;
a readout circuit configured to receive sensing signals from the plurality of light sensors through readout lines and to generate sensing data based on the sensing signals; and
a touch processor configured to generate touch information based on the sensing data,
wherein the display panel is configured to determine whether the touch pen touches the display panel based on characteristics of the light.

12. The display device of claim 11, wherein the touch processor comprises:
a sensing value storage unit configured to store the sensing data;
a light irradiation area determination unit configured to determine a light irradiation area based on the sensing data stored in the sensing value storage unit;
a light characteristic detection unit configured to generate a light characteristic signal, based on the light irradiation area and the sensing data; and
a touch information generation unit configured to generate the touch information, based on the light irradiation area and the light characteristic signal.

13. The display device of claim 12, wherein the light irradiation area determination unit is configured to receive an intensity of light sensed from a light sensor corresponding to a first position, and is configured to determine whether the first position is in the light irradiation area, based on whether the intensity of the sensed light is equal to or greater than a first reference value.

14. The display device of claim 13, wherein the light characteristic detection unit is configured to analyze characteristics of light irradiated in the light irradiation area, and
wherein the touch information generation unit is configured to determine whether the touch pen touches the display panel, based on a result of the analysis.

15. The display device of claim 14, wherein the light characteristic detection unit is configured to generate light characteristic information comprising information relating to the intensity of the light irradiated in the light irradiation area, and
wherein the touch information generation unit is configured to determine that the touch pen touches the light irradiation area based on the intensity of the light being equal to or greater than a second reference value, and is configured to determine that the touch pen does not touch the light irradiation area based on the intensity of the light being less than the second reference value.

16. The display device of claim 14, wherein the light characteristic detection unit is configured to generate light characteristic information comprising information on a blink frequency of the light irradiated in the light irradiation area, and
wherein the touch information generation unit is configured to determine that the touch pen touches the light irradiation area based on the blink frequency of the light being equal to or greater than a third reference value, and is configured to determine that the touch pen does not touch the light irradiation area based on the blink frequency of the light being less than the third reference value.

17. The display device of claim 14, wherein the light characteristic detection unit is configured to generate light characteristic information comprising a code corresponding to a pattern of the light irradiated in the light irradiation area, and
wherein the touch information generation unit is configured to determine that the touch pen touches the light irradiation area in response to a determination that the code corresponds to a first code, and is configured to determine that the touch pen does not touch the light irradiation area in response to a determination that the code corresponds to a second code different from the first code.

18. The display device of claim 13, wherein the light characteristic detection unit is configured to generate light characteristic information comprising information on a position where light of a maximum intensity is irradiated in a light irradiation area,
wherein the touch information generation unit is configured to generate a touch position based on the light characteristic information, and
wherein the touch information generation unit is configured to determine a tilt value indicating an angle at which the touch pen is inclined, based on a shape of the light irradiation area and the touch position.

19. The display device of claim 12, wherein the touch processor is configured to count a number of light sensors in the light irradiation area, determine whether the number of light sensors is equal to or greater than a fourth reference value, and reduce sensitivity of the light sensors in response to the number of light sensors being equal to or greater than the fourth reference value.

20. An electronic device comprising:
a processor configured to provide input image data; and
a display device configured to display an image based on the input image data, wherein the display device comprises:
a display panel comprising a plurality of light sensors configured to sense light irradiated from a touch pen;
a readout circuit configured to receive sensing signals from the plurality of light sensors through readout lines and to generate sensing data based on the sensing signals; and
a touch processor configured to generate touch information based on the sensing data, and
wherein the display device is configured to determine whether the touch pen touches the display panel based on characteristics of the light.
